(19) United States
(12) Patent Application Publication
(10) Pub. No.: US 2015/0260566 A1
(43) Pub. Date: Sep. 17, 2015

(54) REVERSE WEIGHING TRAY SCALE AND CONTROLLER

(71) Applicant: Clint Conder, Grand Junction, CO (US)

(72) Inventor: Clint Conder, Grand Junction, CO (US)

(21) Appl. No.: 14/659,611

(22) Filed: Mar. 16, 2015

Related U.S. Application Data
(60) Provisional application No. 61/953,813, filed on Mar. 15, 2014.

(51) Int. Cl. G01G 19/414

(52) U.S. Cl. CPC G01G 19/414

(57) ABSTRACT

A reverse weighing system for measuring the amount of a food item which has been removed from a food serving tray is provided. A menu system interactive with the weighing system to provide ingredient and ingredient portion information associated with a purchased menu item is also provided.

### RELATED APPLICATIONS

The present application claims the benefit of U.S. Provisional Application Ser. No. 61/953,813, filed Mar. 15, 2014, which is herein incorporated by reference in its entirety.

### THE FIELD OF THE INVENTION

The present invention relates to food services. In particular, examples of the present invention relates to a system for providing accurate portions in serving food.

### BACKGROUND

At restaurants where servers pull food such as meat from a steam tray to be served to customers, it is difficult for the server to serve the correct amount of food, as serving tongs have no inherent portioning characteristics, and portion size is judged by apparent size which is a very unreliable method. In addition, customers often pressure the server into serving more food (particularly meat) than is authorized. This often results in restaurants spending hundreds of dollars more per week on meat than is necessary.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1: A rendering of the system; steam table, trays, multiple tray inserts, connected by wires to a single controller.

FIG. 2: A bird's eye rendering of the system, with customers and server.

FIG. 3: A process diagram, showing how the system would work.

FIG. 4: A detailed rendering of the tray insert, showing how it would interface with a food tray.

FIG. 5: A detail view of the tray insert front panel, showing the necessary interface for a Bluetooth connection to the controller.

FIG. 6: A top view of the tray insert, showing the location of force transducers and the front panel.

FIG. 7: A cross-section of the tray insert, tray, and table, showing the parts of the pan scale, and how it would interface with a food tray.

FIG. 8: Electronic components map of the wired version of the tray insert.

FIG. 9: Electronic components map of the Bluetooth version of the tray insert.

FIG. 10: Electronic components map of the Bluetooth version of the tray insert which would connect to an Android device.

FIG. 11: Front view of the wired controller, showing the wire ports and on/off button.

FIG. 12: Top view of the wired controller, showing the LCD screen, TARE button, on/off button, and wire ports.

FIG. 13: Electronic components map of the wired version of the controller.

FIG. 14: Top view of Bluetooth controller type A—capable of only connecting to a single pan scale.

FIG. 15: Electronic components map of Bluetooth controller type A.

FIG. 16: Top view of Bluetooth controller type B—capable of connecting to multiple pan scales.

FIG. 17: Electronic components map of Bluetooth controller type B.

FIG. 18: Top view of Bluetooth controller type C—capable of programming target weights and ranges for multiple pan scales.

FIG. 19: Back view of Bluetooth controller type C, showing the two legs that create a space underneath the controller.

FIG. 20: Bottom view of Bluetooth controller type C, showing the buttons that are on the bottom-side of the controller, used to program target weights and ranges.

FIG. 21: View of type C default programming menu.

FIG. 22: View of type C programming menu after a target weight and range have been set.

FIG. 23: View of Bluetooth controller type C Bluetooth Connection Interface.

FIG. 24: Bottom view of Bluetooth controller type C, showing how the buttons are used in the Bluetooth Connection Interface.

FIG. 25: Electronic components map of Bluetooth controller type C.

FIG. 26: Interface diagram of the Pan Scale Android App, explaining the Serving, Manage Devices, and Program Settings functions.

FIG. 27: Interface diagram of the Pan Scale Android App, explaining the Sign-in/out and History functions.

FIG. 28: Electronic components map of the Android Device.

FIG. 29: Tray Insert Firmware Diagram

FIG. 30: Diagram of 3-Point Tray Insert Configuration

FIG. 31: Diagram of Single-Unit Steam Tray Scale

FIG. 32: Rendering of Pan Scale Table

FIG. 33: Schematic of example components of a communications computer

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The disclosure particularly describes how to improve portion control in restaurants and the food service industry. Particularly, the present disclosure describes how a computer weighing system may be used to accurately weight food as it is removed from a tray such as a steam heated tray in a restaurant.

A reverse-weighing mechanism may be connected to a viewing screen that allows the server to measure how much of a food item such as meat he has removed from the steam tray. This also provides the customer with an assurance that they are indeed receiving the correct portion of meat. Using this invention, restaurants may save hundreds of dollars per week simply on meat. Application to other expensive food items, such as cheese, can result in further savings. In addition, this invention can potentially provide greater accountability between servers and restaurant managers, as managers can pinpoint which servers are serving larger portions than authorized.

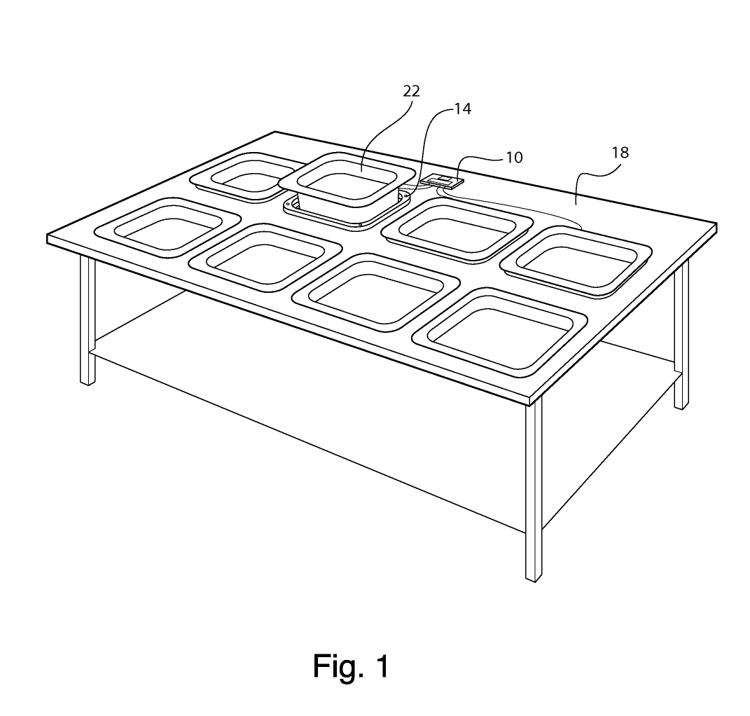

Referring now to FIG. 1, a reverse food weighting system may include a computer 10 which communicates with various scales 14. The computer 10 may be embodied by a purpose built computer 10 which is installed on the food table 18. Alternatively, the computer 10 may be embodied as another computer such as a tablet computer, laptop computer, etc. The computer 10 typically includes software (e.g. a weighting module) which includes programming to allow the computer to implement the various steps and protocols discussed herein. The computer 10 may also have inlet and outlet communications devices (e.g. USB ports, serial communications ports, etc.) to allow the computer to interface with the scales 14. The communications ports may be an integral part of the computer or may be a stand-alone device.

The scales 14 receive a food tray 22. In one example, the scales may be C shaped or hoop shaped, having an open interior cavity which receives the food tray 22. The table 18 may be a steam table or an ice table which keeps food hot or cold. The scales 14 are typically about one half of an inch thick and may be installed on the top of the table 18 so that the food trays 22 may extend through the scale 14 and into the heated or cooled space provided by the table 18. In one example, the scales 14 have pressure sensors in each corner and use a mathematical combination of the pressure sensor readings to sense the weight of the food which is inside of the food tray 22.

The computer 10 and sensors 14 are particularly adapted to weigh food items. In discussing the computer and scales, it is appreciated that certain functionality may be distributed between the computer and scales and other accessory hardware in different manners. For example, the computer 10 may include a majority of the hardware and software and the scales 14 may be little more than sensors. In another example, the scales 14 may include onboard processors and may perform many of the calculations and functionality discussed herein.

Rather than weighing the food in a conventional manner, the computer 10 and scales 14 weigh in reverse. That is to say that rather than increasing the displayed weight when material is added to the scale pan and vice versa, the computer 10 and scales 14 weigh in reverse and show an increasing weighted quantity as food is removed from the scale pan (the food tray 22). Thus, the scale/computer may identify and track/record that there is a certain quantity of food in the tray 22, such as 8 pounds of meat. When meat is removed from the tray to serve a customer, the computer 10 or scale 14 may display the quantity of meat which has been removed and not the quantity which remains in the tray. Thus, if 8 ounces of meat are removed from the tray, the computer displays 8 ounces rather than 7.5 pounds. Additionally, the computer 10 or scale 14 (as a display may be formed in either device although it is often more convenient to have a display in the computer 10) may display the quantity as a positive quantity (8 ounces) even though the amount of meat in the tray has diminished. In this manner, the computer directly identifies the portion amount taken by the food service employee.

The computer 10 may allow the employee to adjust the amount of meat which has been taken for a predetermined period of time such as 5 seconds which is sufficient time to serve a customer from the food tray 22. In this period of time, the computer 10 and scale 14 may allow the employee to return food to the tray 22 to decrease the weighed and displayed amount of food and may allow the employee to take additional food from the tray to increase the weighed and displayed amount of food. In this manner, the employee may quickly and accurately remove an appropriate amount of food for a customer which is consistent with portion guidelines set by the restaurant.

The computer 10 may reset the stored total weight corresponding to the total amount of food in the tray 22. The computer 10 may identify a discrete period of time during which a food portion is being dispensed and may adjust the displayed portion weight during that period of time. After the dispensing period of time, the computer may identify a non-dispensing period of time and/or a second dispensing period of time. During a second dispensing period of time, the computer may display the weight of food removed from the tray during the second dispensing period of time only in the manner discussed.

In one example, the computer 10 may require an employee to press a button to start or end a dispensing period of time. In one example, the computer 10 may wait for an elapsed period of time such as 5 seconds to close the first dispensing period of time and begin a non-dispensing period of time or a second dispensing period of time. After this period of time, the computer 10 may attribute any changes in the tray weight due to food removal to dispensing a second portion during a second dispensing period. In another example, the computer 10 may track the sensed weight of the tray 22 and may identify a period of time during which the weight of the tray 22 does not change (i.e. a non-dispensing period of time). If the computer senses a sufficiently long period of time during which no food is dispensed (such as 2 seconds) the computer may identify this sensed period of time as a non-dispensing period of time and may close the first dispensing period of time. Thereafter, if the computer sensed any dispensing of food from the tray 22 via a reduction in weight of the tray 22, the computer 10 may start a second dispensing period of time and display the amount of food removed from the tray during the second dispensing period of time, allowing the employee to adjust the portion of dispensed food up or down as has been discussed.

The computer may be programmed to ignore certain food tray weight changes which are sensed by the scale 14. For example, the computer 10 and scale 14 may sense a momentary increase in total weight of food in the tray 22 when an employee places silverware such as tongs or a scoop into the tray 22. In this situation, the computer 10 may sense that the food tray 22 weighs 10 pounds in total, may sense a momentary increase in weight to 10.3 pounds, and then may sense a reduction in total weight to 9.4 pounds. Responsive to this period, the computer 10 may display that 0.6 pounds or 9.6 ounces of food has been removed from the tray 22. In this manner, the computer 10 may display the negative value of the net change in food weight in the tray over a dispensing period of time as the dispensed portion. The computer 10 may begin the dispensing period of time with the pre-dispensing food tray weight so that any initial force into the tray with the dispensing silverware is disregarded as net dispensed weight. Conventional scales weigh what is put on the scale. The present system weighs what comes out of the scale pan.

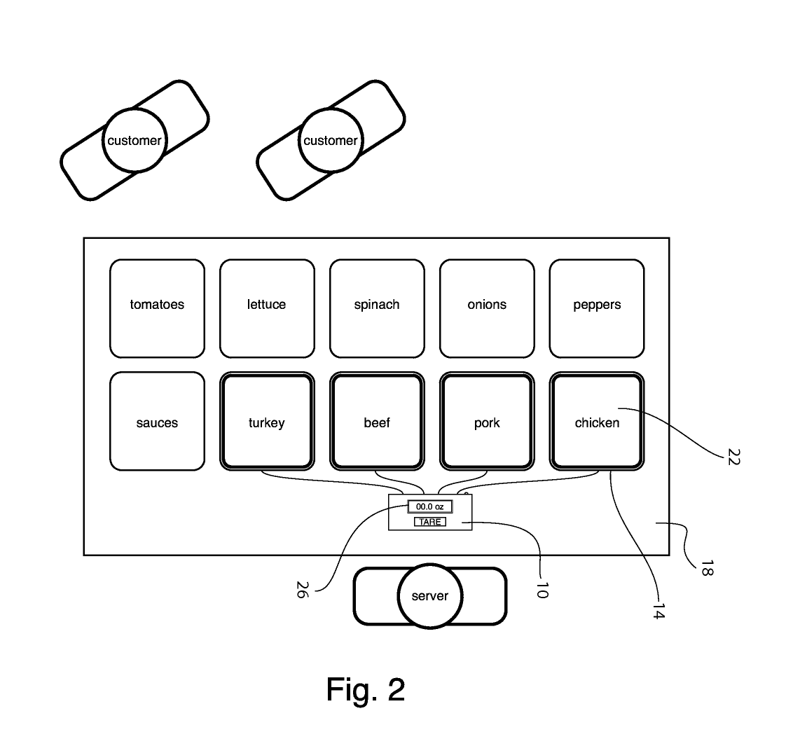

The table 18 and, more particularly, the computer 10, may be connected to the internet or a WIFI network and may allow communications with customers. When a potential customer comes into the restaurant. The customer can use a mobile phone APP or a website to order their meal. The customer can pay for his meal and sit down without having to wait in line by using a credit card or electronic funds transfer via the website or the APP. The website or App will then transmit the order (via a wireless network or the internet) over to the computer 10 and thus to the employees at the steam table. The computer 10 will then prioritize the orders coming in for production on the screen 26 (FIG. 2). The computer 10 will take the first order and put it into a cue for production. The computer 10 includes a data base which stores the restaurant recipe's and their respective ingredients and portion weights, sequence of assembly, etc. The scales may have indicator lights built therein and a series of lights on the scales or on the computer display 26 may be used to tell the employee which ingredient is next and the computer may display the amount of product being taken out of the steam pan 22.

When the employee gets the amount or food from a particular tray 22 right, computer 10 may indicate this with a green light on the display, and may display a + or a − to indicate that the employee needs to add additional food or removed food from the portion. The computer 10 may then indicate the next ingredient in the recipe for that menu item. The computer display 26 may be sufficiently large to display additional text messages to the employee. For example, a first portion of the display 26 may display the menu item to the employee. A second portion of the display 26 may display the current food ingredient to the employee. A third portion may display the desired portion weight of that food item to the employee. A fourth portion of the display 26 may display the current actual weight of food removed from the tray 22 to the employee. The computer 10 may allow the employee to press a button such as NEXT button when the food amount is right and the computer 10 may then display the next food ingredient, desired portion weight, and actual dispensed weight. As the computer 10 may be connected to multiple food trays 22 as displayed in the figures, a single computer 10 may display the recipe and may be used to weigh all desired food items on the steam table—food preparation area of the restaurant.

The computer 10 may monitor all foods being weighed and removed from the weighed food trays 22 and may print out, at the end of the day, all inventory used so that it can be matched with inventory entered into a restaurant inventory management or point of sale system. This allows the computer 10 and associated system to monitor all food items and their portion sizes as they come off the front line. This may be used to eliminate errors of portioning that waste food, saving money for the restaurant.

The computer 10 uses a reverse weighing process that displays weights that are taken out of the tray 22 monitored by a scale 14. We then match this process with a predetermined “Tare” amount that acts as a point of origin and the computer 10 will not allow the scale to go backwards when a tong is pushed in to the pan; adding more weight to the tray 22. The computer 10 will monitor what comes out of the tray 22 as a net weight removed, not what is temporarily pushed into the tray 22. Thus an accurate reading is established. The table 18 may include a series of scales 14 or weight/pressure sensors for each desired tray location. These sensors/scales 14 work together to establish the weight and the amount that comes out of each of the trays 22.

In one example, a scale 14 may be provided as a discrete item which may be placed underneath an existing steam table tray 22 (sometimes referred to as a pan). The scale 14 can be used on one pan at a time instead of a whole steam table and can be direct wired or battery operated. The scale 14 may include a LED display and will monitor what comes out of the pan as discussed above. Such a scale may be used if an employee has one particular item that needs monitoring to allow a restaurant to correct a particular problem.

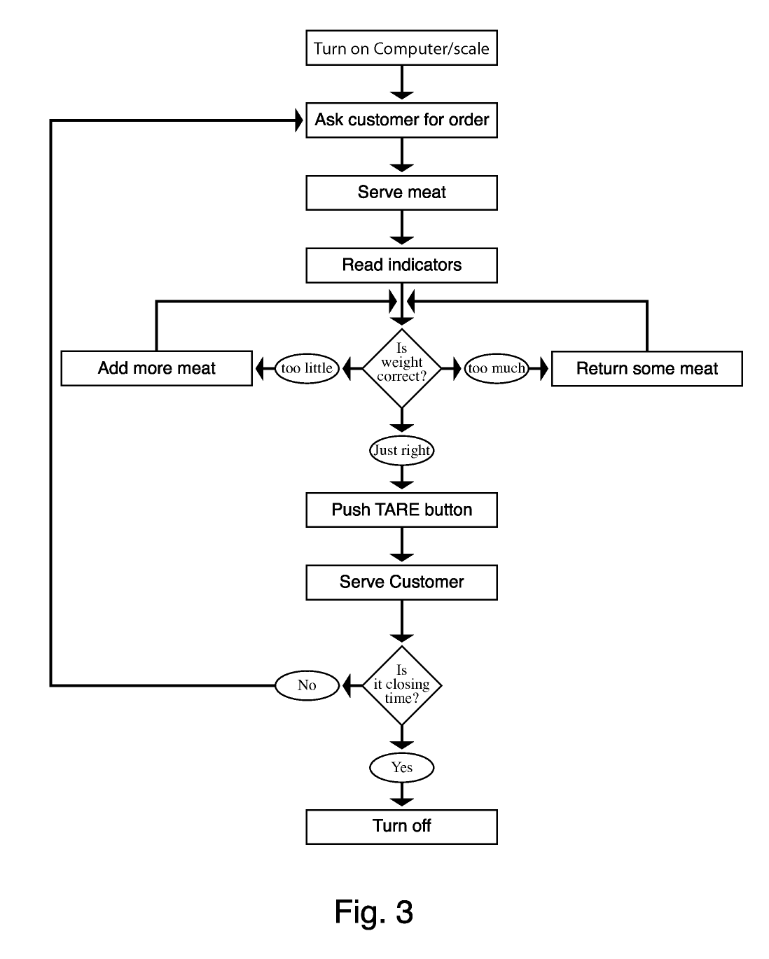

FIG. 3 shows the general process discussed above to remove a portion from a tray 22 and to display, as a positive portion weight, an amount of food removed from the tray 22.

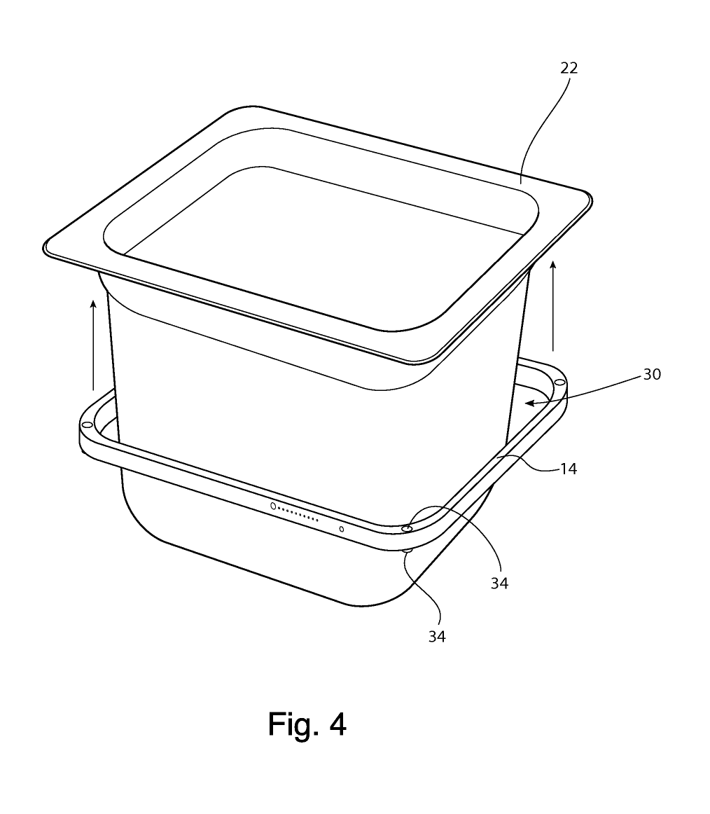

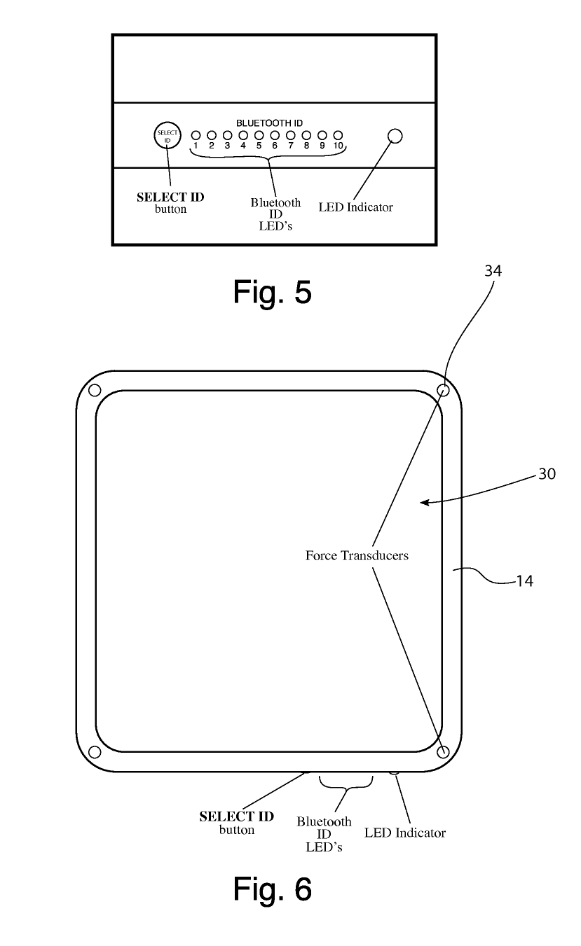

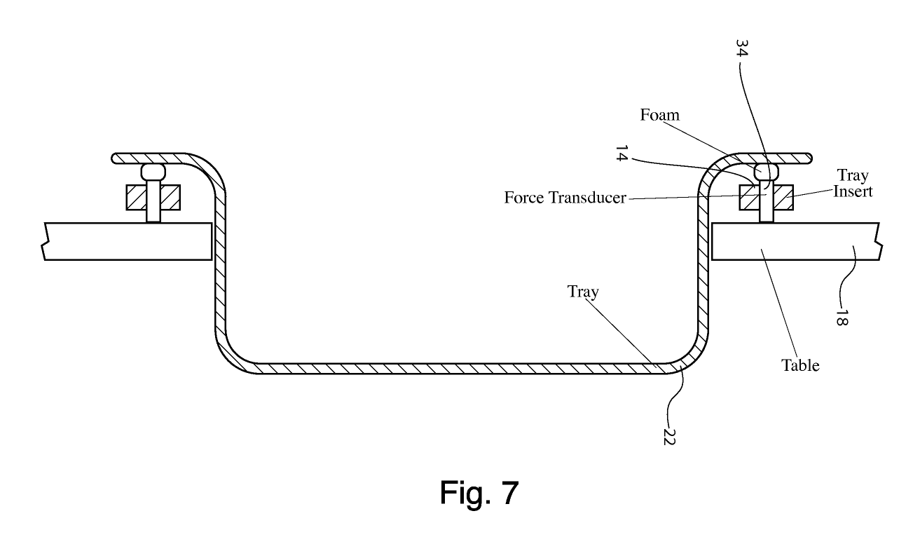

FIG. 4 shows a scale 14 and tray 22. The scale 14 may have an opening 30 into which the tray 22 fits. The scale 14 may have sensors 34 which sense weight and which transmit weight data to the computer 10 to allow the computer to determine the weight of the tray 22 and food and to determine the amount of food which is removed from the tray 22. FIG. 6 shows a top view of the scale 14. The scale 14 may interface with a standard steam table tray by fitting around the steam table tray cavity and receiving a tray 22, with the scale between the tray 22 and rim of the table 18 as is indicated in FIG. 7. FIG. 5 shows in greater detail how the scale 14 may include indicator lights, WIFI or Bluetooth capability, and individual select, tare, or reset buttons. The scale 14 may include, at locations such as at each of the four corners of the device, force transducers 34 that together weigh the tray and its contents. The scale may include, between the force transducers and the tray 22, a cushion such as a layer of foam that allows out-of-shape trays to still touch all four corners (see FIG. 7).

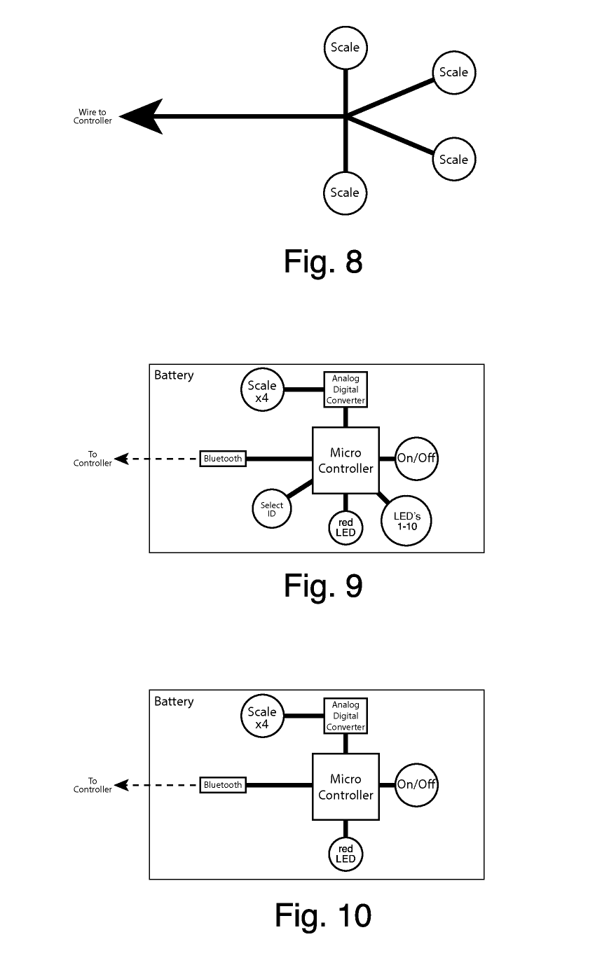

The electronic components of the scale 14 may include force transducers 34, an Analog-Digital Converter, and a wire that connects to the controller (e.g. computer 10 or a small controller on the scale 14) as is shown in FIGS. 8, 9, and 10. FIG. 11 shows how the scale 14 may include indicators and buttons 42 as desired.

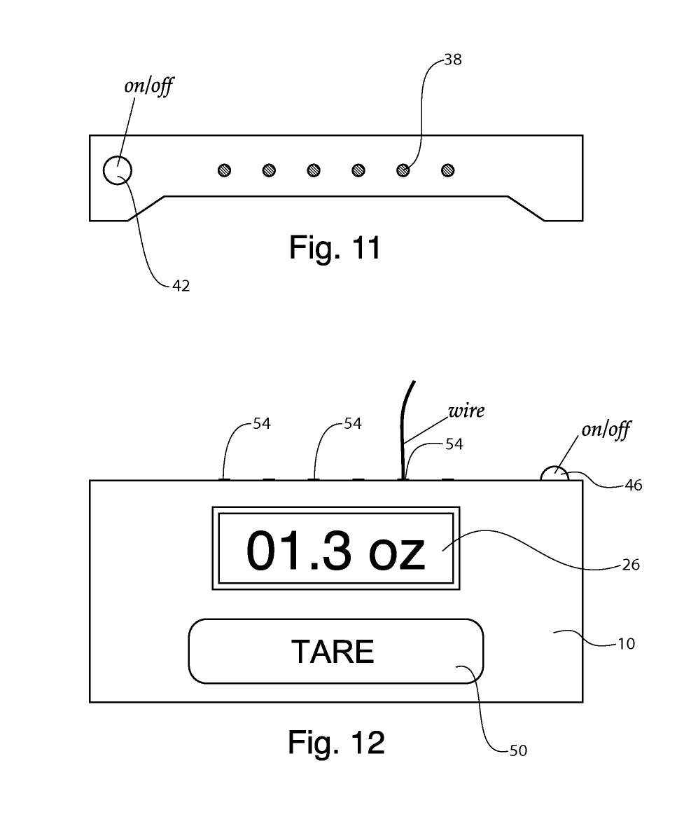

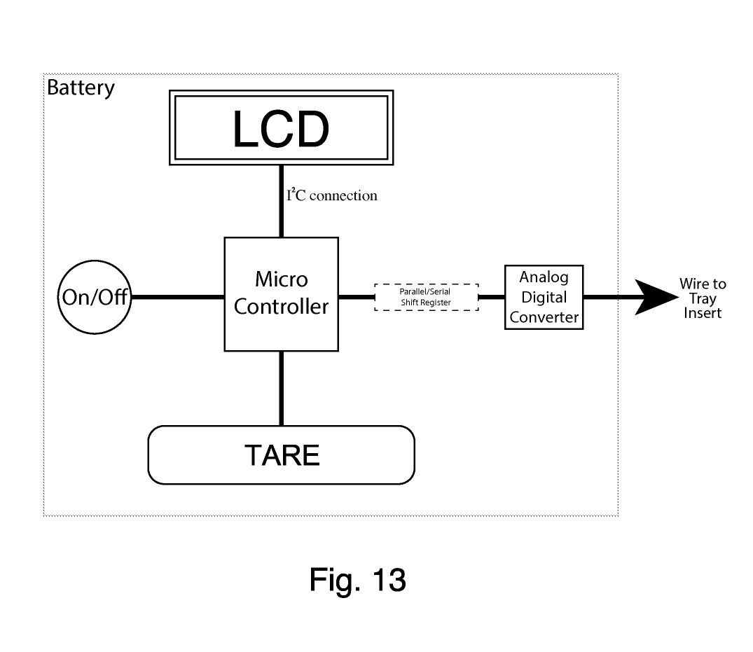

FIG. 12 shows how the computer 10 may include an On/Off switch 46, an LCD display 26 capable of displaying up to 99.9 oz (as an example), a TARE button 50 which resets the weight to 00.0 oz, and wire ports 54 for connecting different scales 14. The computer may include a Micro Controller that is connected to the LCD via an I²C connection (for example), connections to the On/Off and TARE buttons, and connections to a Parallel/Serial Shift Register that receives the wires from the various tray inserts. Meanwhile, a battery may provide power to all components.

Variations

Bluetooth Tray Insert Type A: Same as Wired Tray Insert, except that instead of being connected to a controller via wire, is connected to Bluetooth Controller Type A via Bluetooth.

The electronic components of the tray insert (see FIG. 10) consist of the four force transducers connected to an Analog-Digital Converter, which is connected to a Micro Controller. The Micro Controller is connected to the On/Off button, a red indicator LED, and a Bluetooth transmitter.

This Tray Insert is the only insert communicating with the controller. The controller paired with this insert connects with it automatically.

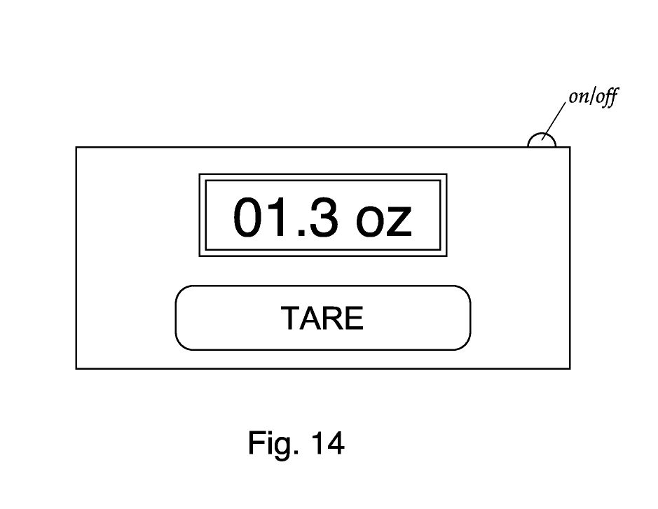

Bluetooth Controller Type A: Same as Wired Controller, except that instead of being connected to a tray insert via wire, is connected to Bluetooth Tray Insert Type A via Bluetooth (see FIG. 14).

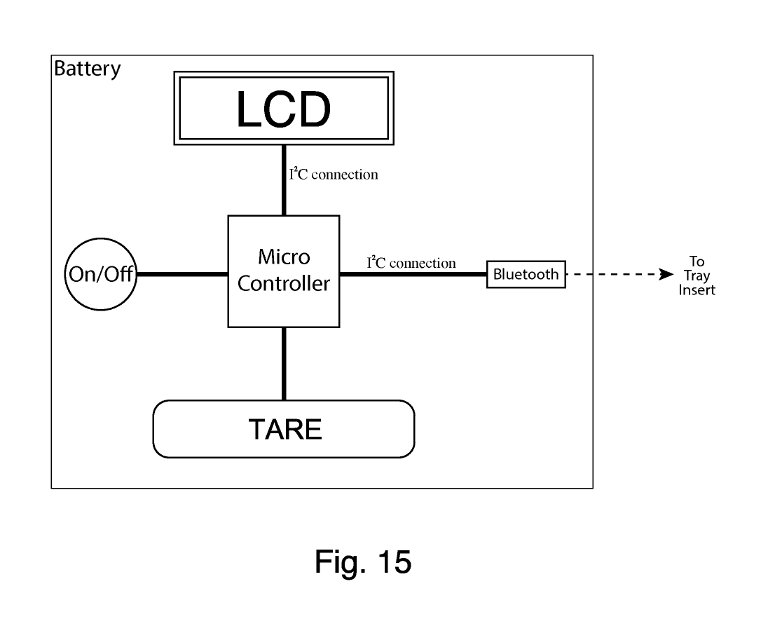

The electronic components of the controller (see FIG. 15) consist of a Micro Controller that is connected to the LCD via an I²C connection, connections to the On/Off and TARE buttons, and connections to a Bluetooth transmitter via an I²C connection. Meanwhile, a battery provides power to all components.

This Controller communicates with only a single tray insert that is always paired with it, and connects to it automatically.

Bluetooth Tray Insert Type B: Same as Tray Insert Type A, except that instead of being the only tray insert connecting to a controller, multiple tray inserts can all connect to a single Type B controller via Bluetooth.

This communication is managed through the use of Bluetooth ID's, which can be individually selected by each tray insert through the use of a Select ID button and ten LED's labeled 1-10, both of which are found on the front face of the tray insert (see FIGS. 4, 5 and 6).

The tray/scale interface may work as follows:

Press the Select ID button, and LED 1 will turn on. Press Select ID

again for LED 1 to turn off, and LED 2 to turn on. In this manner, choose a

Bluetooth ID for that tray insert. LED's turn off after 10 sec of inaction.

The electronic components of the tray insert (see FIG. 9) consist of the four force transducers connected to an Analog-Digital Converter, which is connected to a Micro Controller. The Micro Controller is connected to the On/Off button, a red indicator LED, a Select ID button, LED's 1-10, and a Bluetooth transmitter.

Bluetooth Controller Type B: Same as Bluetooth Controller Type A, except with the ability to connect via Bluetooth to multiple Type B tray inserts.

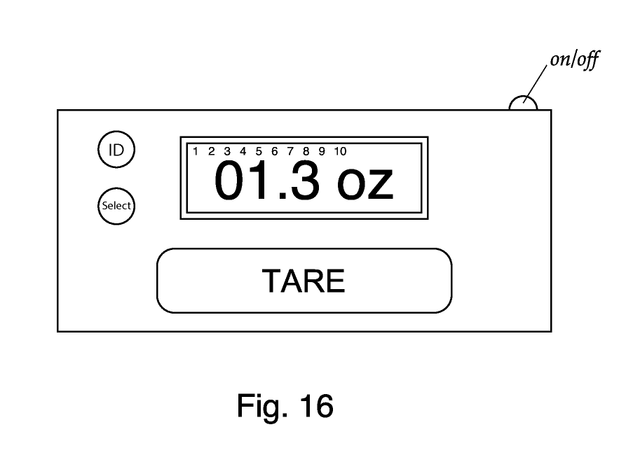

The multiple tray inserts are managed by using two additional buttons found on the front the controller: the ID and Select buttons (see FIG. 16). In addition, the LCD has the numbers 1-10 on the top edge which can light up individually.

The controller interface may work as follows:

Push ID button, LCD 1 starts blinking. Pushing ID again will shift the blinking # over to LCD 2, 3, etc., depending on the number of times pushed.

While, for example, LCD 4 is blinking, pressing SELECT causes that LCD to stay on—no more blinking (this Bluetooth channel has been selected). Pressing ID again will leave 4 on, while making 5 to start blinking. Pressing SELECT will cause 5 to stay on as well. Pressing SELECT again will cause 5 to start blinking again (deselected). In this manner, Bluetooth channels 1-10 can be selected.

After 10 sec of inactivity, all blinking LCD #'s will turn off.

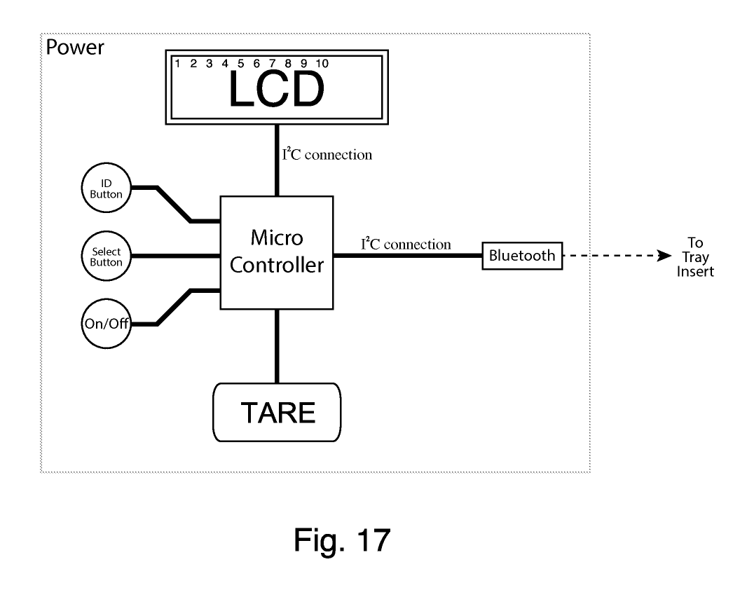

The electronic components of the controller (see FIG. 17) consist of a Micro Controller that is connected to the LCD via an I²C connection, connections to the On/Off, TARE, ID, and Select buttons, and connections to a Bluetooth transmitter via an I²C connection. Meanwhile, a battery provides power to all components.

Bluetooth Controller Type C: Same as Bluetooth Controller Type B, except with the ability to 1) have programmed and 2) display the target weight and ranges of meat portions for each type B tray insert it is connected to.

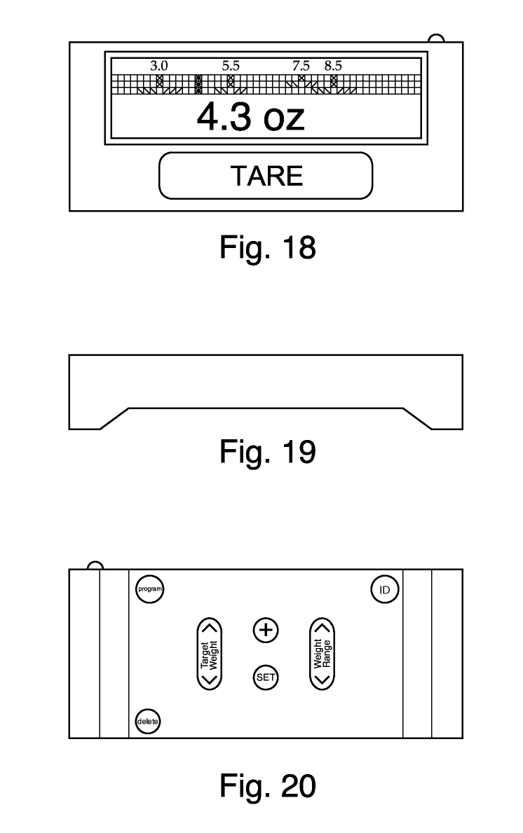

The LCD has, above the 00.0 oz display area, three rows of pixels which run the width of the LCD. Above that is another row capable of displaying any configuration of numbers and decimals (see FIG. 18).

As seen from the rear profile (see FIG. 19), the controller sits on two legs which lift up the underside. On the underside of the controller (see FIG. 20) are an assortment of buttons which are used to both A) program the target weight and ranges of the various tray inserts and B) manage the connections with the various tray inserts.

The programming interface may work as follows:

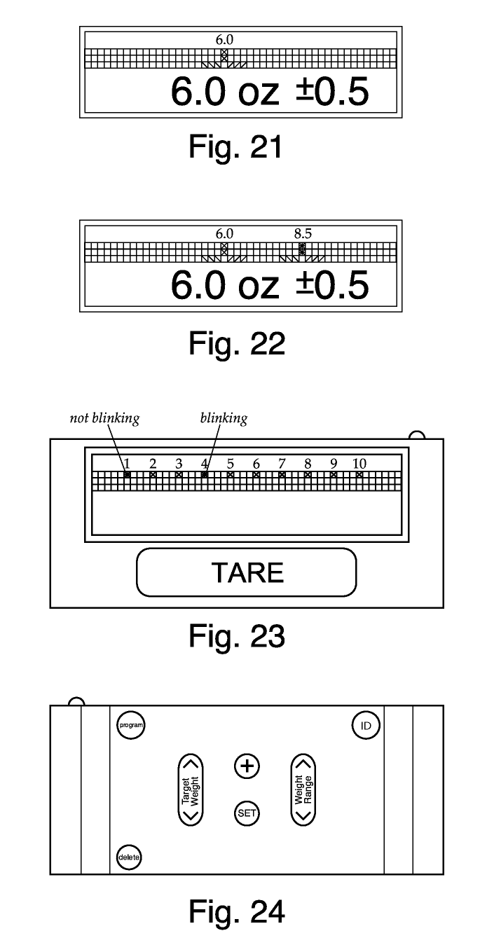

Pushing the PROGRAM button on the underside of the controller will light up an Insert's red LED and the screen will show a blinking default target weight and range (see FIG. 21).

Pressing the Target Weight arrows will change the target weight. Pressing the Weight Range arrows will change the weight range. Pressing SET will turn off the tray insert's red LED and will return the screen to zero weight.

Before the default weight settings have been altered, the PROGRAM button may be pushed multiple times to select the appropriate tray insert, as seen by the various insert's red LED indicators. After the default settings have been altered, pushing the PROGRAM button will cause no action until SET is pushed.

Pressing PROGRAM again will show a previously programmed target weight, with the corresponding tray insert's red LED lit up. Pressing the + button will bring up an additional blinking default target weight, while still showing the first programmed weight (not blinking) (see FIG. 22).

This new target weight can be programmed and stored by pushing the Target Weight/Weight Range arrows, and then pushing SET.

Pushing the + button multiple times will alternate selection between the various programmed weights and the default setting, with blinking indicating what is currently selected.

While a programmed weight is currently selected (blinking), it can be deleted by pushing the DELETE button.

The memory of these programmed target weights are stored in a way that even changing Bluetooth ID's will not mess up the settings.

The Bluetooth connection interface works as follows:

Pushing the ID button will bring of the ID Selection Menu (see FIG. 23). The square under 1 will be blinking. A blinking square is a Bluetooth channel that is in a position to be selected. A black square (not blinking) is a selected Bluetooth ID. Bluetooth ID's can be selected and deselected using the buttons on the bottom of the controller, in the following manner:

ID=press to bring up ID Selection menu; press again to turn off ID Selection menu

PROGRAM=does nothing in ID Selection menu

TARGET WEIGHT Arrows=back and forth between 1-10

WEIGHT RANGE Arrows=back and forth between 1-10

DELETE=will deselect a selected ID; otherwise, nothing

SET=will select a blinking ID; press again to deselect

+=will select a blinking ID; press again to deselect

TARE=does nothing in ID Selection menu

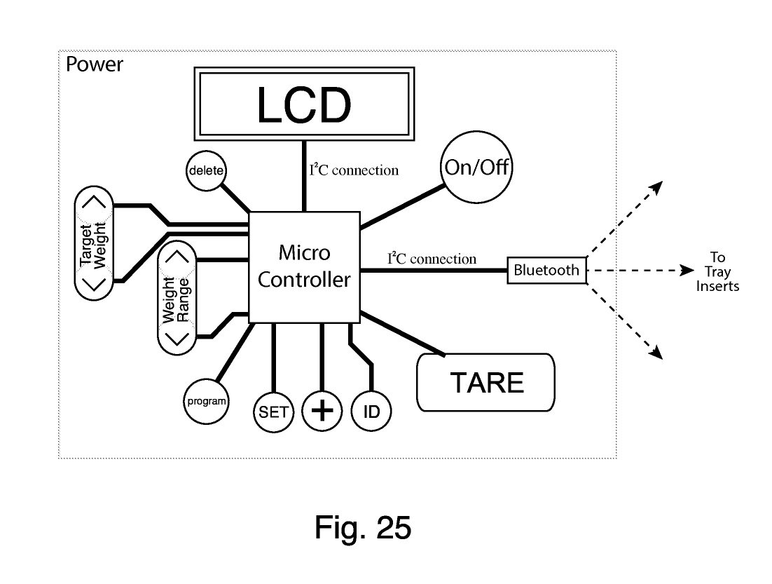

The electronic components of the controller (see FIG. 25) consist of a Micro Controller that is connected to the LCD via an I²C connection, connections to the On/Off, TARE, ID, +, SET, PROGRAM, WEIGHT RANGE, TARGET WEIGHT, and DELETE buttons, and connections to a Bluetooth transmitter via an I²C connection. Meanwhile, a battery provides power to all components.

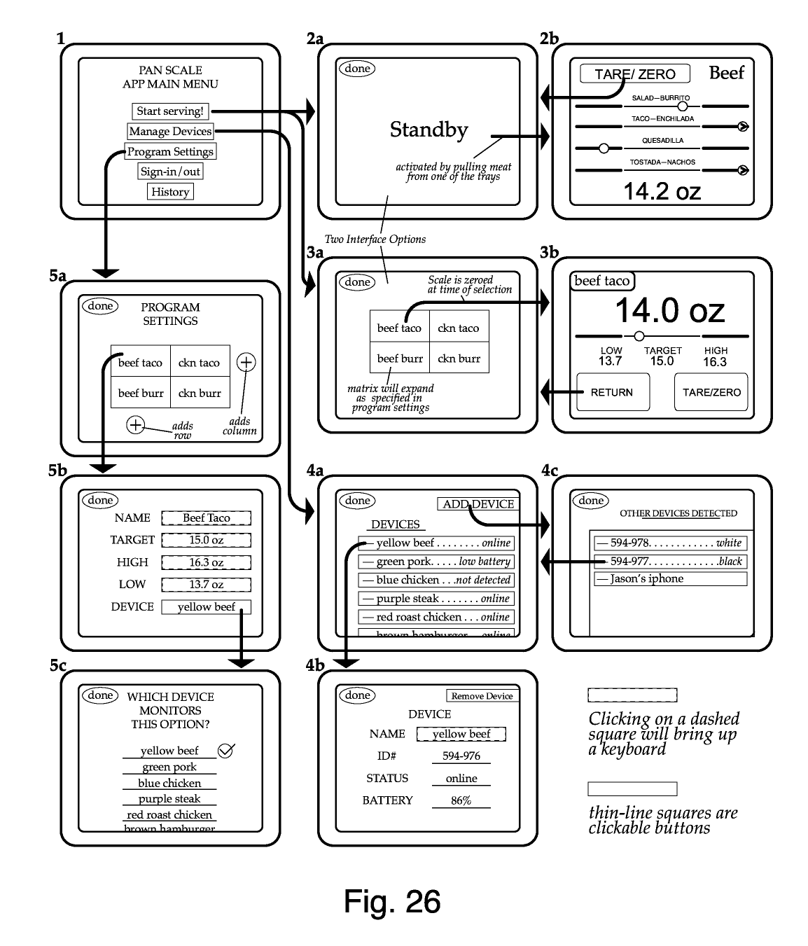

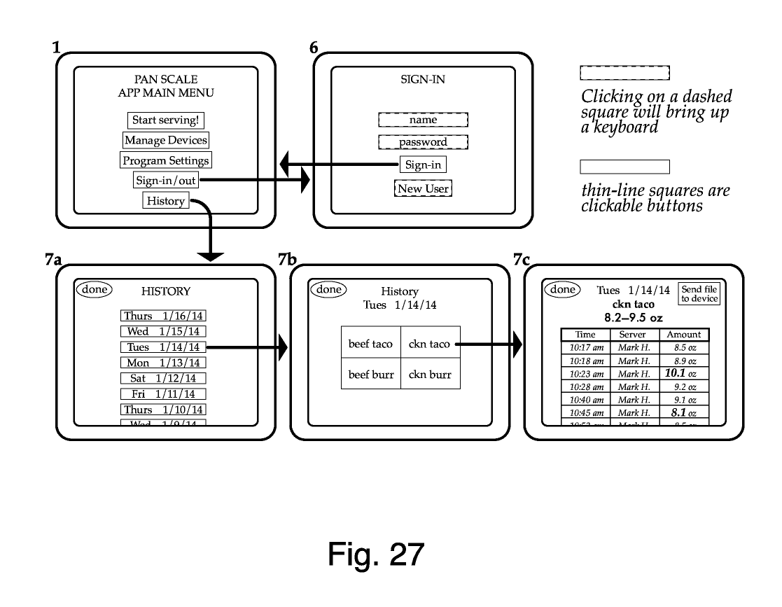

Android Tablet Controller: a touchscreen tablet which runs the Android Operating System, and is equipped with the Pan Scale App. The Pan Scale App allows the tablet to connect via Bluetooth to multiple tray inserts, to program target weight and range settings for various recipes, to keep track of the portion serving history, and to keep track of which server is serving at what times, in addition to using the tray inserts as reverse-weighing mechanisms. The interface of the App is explained in FIGS. 26 and 27.

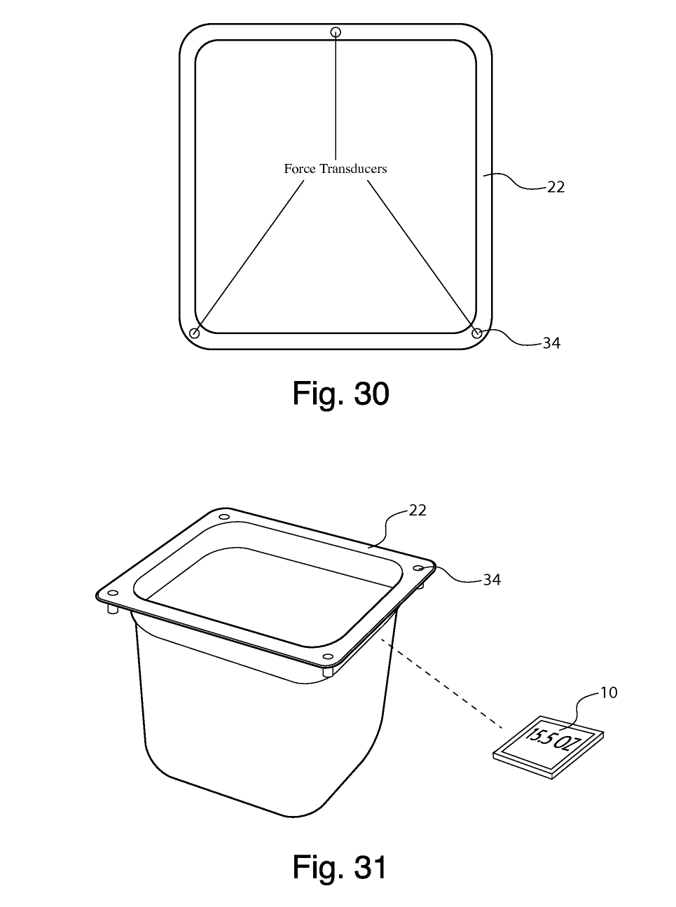

3-point Tray Insert Configuration: Same as all above tray inserts, except that instead of four force transducers positioned at each corner, three force transducers are positioned at two corners and the middle of the opposite side, respectively (see FIG. 30). The advantage of this configuration is that the steam tray, no matter how out-of-shape, will always rest firmly on the force transducers, removing the need for a layer of foam above the force transducer.

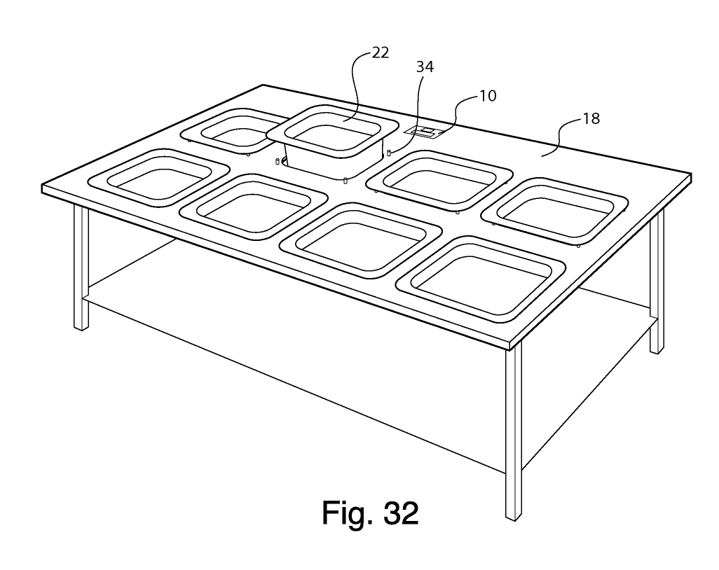

Single-Unit Steam Tray Scale: A variation on the steam tray insert, where instead of an insert, the force transducers and wires/Bluetooth are built into a dedicated steam tray, possibly with the controller/screen mounted on the tray as well (see FIG. 31).

Pan Scale Table: A variation on the steam tray insert, where instead of an insert, the force transducers and controller/screen are built into the steam table itself, designed to accept and reverse-weigh standard steam trays (see FIG. 32).

FIG. 26 illustrates how the computer 10 may be programmed to support integrated restaurant menu functionality as discussed herein. The various computer display screens illustrate show how an employee may input the store menu, menu ingredients, ingredient portion weights, etc. into the scale and may also associate different ingredients with various scales 14 and their respective tray 22. In this manner, the computer 10 may track each ingredient in the various trays 22 rather than only weighing the portion amounts and provide a comprehensive food preparation system.

FIG. 27 shows how the computer 10 may be utilized to provide reporting to the restaurant and may display food portion history including how individual employees portion food. This may assist the restaurant in training employees and in curtailing food waste.

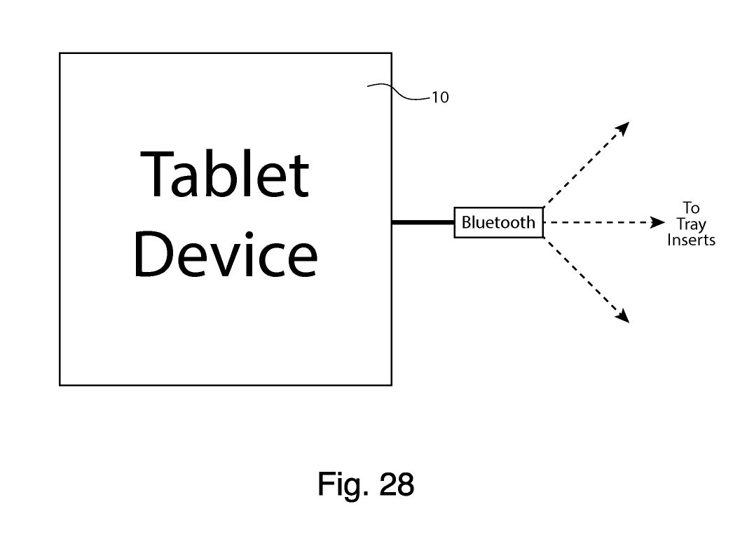

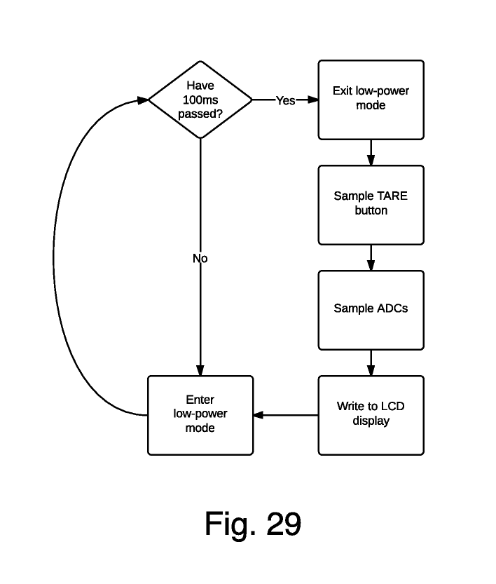

FIG. 28 shows how the computer 10 may be a mobile device such as a tablet and may use a wireless communications adapter such as Bluetooth to communicate with different scales 14.

FIGS. 30 and 31 illustrate how, if desired, the sensors 34 may be made as part of the trays 22. FIG. 32 shows how the table 18 may be made to include the computer 10 and the scale sensors 34 as an integrated assembly.

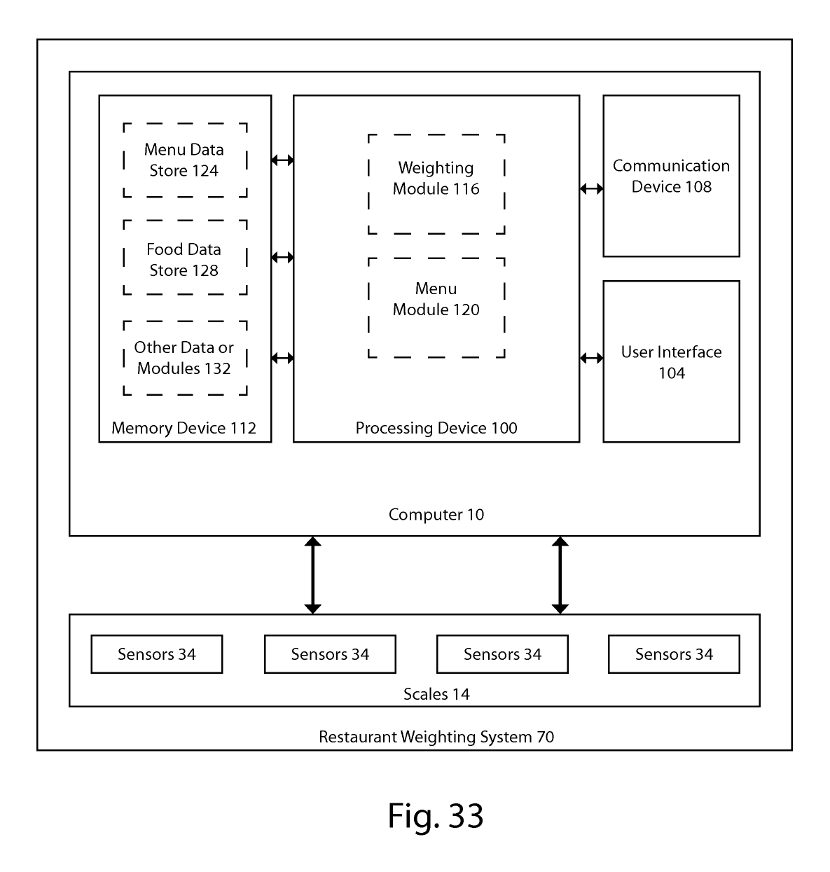

FIG. 33 illustrates how a restaurant weighing system 70 as discussed herein may include a computer 10 and scales 14 in communication with each other. As discussed, the hardware and software of the weighing system 70 may be distributed between the computer 10 and scales 14 in different manners.

FIG. 33 illustrates a schematic with example components of a communications computer 10 is shown. In one example, the computer 10 includes a processing device 100, a user interface 104, a communication device 108, and a memory device 112. It is noted that the computer 10 can include other components and some of the components are not required in every example. The processing device 100 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 100 can execute the operating system of the computer 10. In the illustrative example, the processing device 100 may also execute a weighing module 116 and/or a menu module 120, which may be stored as programmed instructions in the memory device 112 to facilitate operation on the processing device 100.

The memory device 112 may store, as part of the weighing module 116 and/or menu module 120, a menu data store 124, a food data store 128, and other data 132 as is necessary.

The weighing module 116 allows a computer 10 to facilitate the weighing of food withdrawn from a tray 22 as discussed in the examples herein. The menu module 120 may include menu and recipe information and may allow the computer to interface with customer orders and the menu to provide menu ingredient information to employees as discussed herein. The menu data store 124 and the food data store 128 may contain data to facilitate the menu operations and food weighing discussed herein.

The user interface 104 is a device that allows a user to interact with the computer 10. While one user interface 104 is shown, the term “user interface” can include, but is not limited to, a display 26, a touch screen, buttons, a physical keyboard, a mouse, a microphone, and/or a speaker. The communication device 108 is a device that allows the computer 10 to communicate with another device; such as a customer device. The communication device 108 can include one or more wireless transceivers for performing wireless communication and/or one or more communication ports for performing wired communication such as via the internet.

The memory device 112 is a device that stores data generated or received by the computer 10 and may provide data to the processing device 100. The memory device 112 can include, but is not limited to, a hard disc drive, an optical disc drive, and/or a flash memory drive. The memory device 112 may include various components which are part of the weighing module 116 and menu module 120 or used to implement the weighing module 116 and menu module 120 such as the data stores discussed. In particular, the various modules and data stores allow the computer processor 100 to communicate with the sensors 34 and to provide portion information and menu and ingredient information to an employee via the user interface 104 (e.g. display 26 as discussed herein.

The flowcharts illustrate the architecture, functionality, and operation of possible implementations of systems, methods, and computer program products according to certain examples. In this regard, each block in a flowchart may represent a module, segment, or portion of code, which comprises one or more executable instructions for implementing the specified logical function(s). It will also be noted that each block of the flowchart illustration, and combinations of blocks in the flowchart illustration, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The above description of illustrated examples of the present invention, including what is described in the Abstract, are not intended to be exhaustive or to be limitation to the precise forms disclosed. While specific examples of the invention are described herein for illustrative purposes, various equivalent modifications are possible without departing from the broader scope of the present claims. Indeed, it is appreciated that specific example dimensions, materials, voltages, currents, frequencies, power range values, times, etc., are provided for explanation purposes and that other values may also be employed in other examples in accordance with the teachings of the present invention.

1. A reverse weighing system for portioning food having a scale connected to a container bearing food and a control module connected to the scale and programmed to read a positive weight for quantities of food removed from the container.

2. A food weighing system comprising:
a tray;
food located in the tray;
sensors operatively connected to the tray to sense the weight of the tray and food;
a computer system connected to the sensors to receive weight data from the sensors;
a weighing module programmed to:
receive a weight information from the sensors;
identify a first weighing period;
obtain an initial weight reading from the sensors;
monitor reduction in weight of food in the tray during the first weighing period; and
display, via a display associated with the computer, a positive portion weight corresponding to a net reduction in weight of the food in the tray during the first weighing period.

3. The system of claim 2, further comprising:
a menu module programmed to:
receive a selection of a food menu item from a customer;
display, on the display, the selected menu item;
display, on the display, a first food ingredient from the menu item, the first food ingredient being disposed in a first tray having first sensors operatively connected to the first tray and connected to the computer;
wherein the weighing module is programmed to monitor withdrawal of the first food ingredient from the first tray;
wherein the menu module is programmed to display, on the display, a second food ingredient from the menu item, the second food ingredient being disposed in a second tray having second sensors operatively connected to the second tray and connected to the computer; and
wherein the weighing module is programmed to monitor withdrawal of the second food ingredient from the second tray.

4. The system of claim 3, wherein the weighing module is programmed to:
display a positive weight of the first ingredient corresponding to an amount of the first ingredient removed from the first tray; and
display a positive weight of the second ingredient corresponding to an amount of the second ingredient removed from the second tray.

5. The system of claim 3, wherein the computer system includes a communication module programmed to receive a selection of the food menu item from a mobile electronic device of a customer.

6. The system of claim 2, further comprising:
a menu module programmed to:
receive a selection of a food item having multiple food ingredients;
wherein the computer system is connected to a plurality of trays having different food ingredients located therein;
wherein each of the plurality of trays is operatively connected to weight sensors which are connected to the computer system to allow the weighing module to monitor the weight of the trays and the food ingredients located therein;
wherein the computer system is programmed to indicate a first tray having a first food ingredient associated with the food item;
wherein the weighing module is programmed to monitor reduction in weight of the first food ingredient in the first tray during a first weighing period and display, via the display, a positive portion weight corresponding to a net reduction in weight of the first food ingredient in the first tray during the first weighing period;
wherein the computer system is programmed to indicate a second tray having a second food ingredient associated with the food item;
wherein the weighing module is programmed to monitor reduction in weight of the second food ingredient in the second tray during a second weighing period and display, via the display, a positive portion weight corresponding to a net reduction in weight of the second food ingredient in the second tray during the second weighing period.

7. The system of claim 2, further comprising:
a menu module programmed to receive a customer order having a menu item and indicate to a user, via the display, the food located in the tray and to indicate, via the display, how much of the food is portioned for the menu item.

8. The system of claim 2, wherein the computer is programmed to track and report weighing accuracy for the food for a selected time period.

9. The system of claim 2, wherein the computer is programmed to track and report weighing accuracy for the food for a given employee who is dispensing the food.

10. The system of claim 2, wherein the computer is programmed to monitor amounts of the food removed from the tray during a time period and report a total food amount removed from the tray during the time period.

11. The system of claim 10, wherein the computer is programmed to report a number of food portions removed from the tray during the time period.

12. The system of claim 2, wherein the system more specifically comprises:
a scale having an opening therein to receive a food tray;
sensors attached to the scale and disposed around the opening; and
wherein the tray includes a shoulder which rests on the sensors and a food containing portion which extends downwardly through the opening.

13. The system of claim 12, wherein the scale is connected to a food dispensing table.

14. The system of claim 12, wherein the scale surrounds a receptacle in a heated or cooled food dispensing table and the tray is disposed so that a food containing portion of the tray extends through the scale opening and into the receptacle.

15. The system of claim 2, wherein the weighing module is programmed to display an increasing weight of food as food is removed from the tray.

16. The system of claim 2, wherein the weighing module is programmed to display a total positive quantity of food corresponding to a total weight of food removed from the tray during the first weighing period.

17. The system of claim 2, wherein the first weighing period is a predetermined period of time.

18. The system of claim 2, wherein the first weighing period ends after a predetermined period of time without change in the weight of the food in the tray.

19. The system of claim 2, wherein the weighing module is programmed to:
display a total amount of food removed from the tray during the first weighing period as a positive weight;
determine an end of the first weighing period;
begin a second weighing period;
monitor reduction in weight of food in the tray during the second weighing period; and
display a total amount of food removed from the tray only during the second weighing period as a positive weight.
